(19) United States
(12) Patent Application Publication
(10) Pub. No.: US 2011/0097258 A1
(43) Pub. Date: Apr. 28, 2011

(54) METHOD FOR PREPARING GRAPHENE RIBBONS WHERE STRUCTURE IS CONTROLLED

(76) Inventors: Jae-Kap LEE, Seoul (KR); Kyoung-Il LEE, Seoul (KR); So-Hyung LEE, Seoul (KR)

(21) Appl. No.: 12/909,958

(22) Filed: Oct. 22, 2010

(30) Foreign Application Priority Data
Oct. 23, 2009 (KR) 10-2009-0101389

(51) Int. Cl. C01B 31/04; B82Y 40/00

(52) U.S. Cl. 423/448; 977/734

(57) ABSTRACT

Disclosed is a method for fabricating graphene ribbons which are high-functional carbon materials. Provided a method of fabricating graphene ribbons, including (a) preparing a carbon structure in which a graphene ribbon is spirally grown (a graphene helix), revealing a tube shape, and (b) applying energy to unroll the graphene helix into the graphene ribbons.

### RELATED APPLICATION

The present disclosure relates to subject matter contained in priority Korean Application No. 10-2009-0101389, filed on Oct. 23, 2009, which is herein expressly incorporated by reference in its entirety.

### BACKGROUND OF THE INVENTION

1. Field of the Invention

The present invention relates to a high-functional carbon material, and more particularly, to a method of fabricating graphene ribbons from a carbon structure.

2. Background of the Invention

Graphene refers to a single layer of carbon atoms (two-dimensional carbon structure with a thickness of about 4 Å), which is a basic unit of C₆₀, carbon nanotube, and graphite. Due to the strong bond between carbon atoms (referred to as a “sigma bond”), the thinnest material reveals great physical properties better than those of carbon nanotubes. Graphite, which is a typical layered material, is building blocks of graphene layers which are weakly bonded by the van der Waals interaction (referred to as a “pi bond”). Due to the weak binding between graphene layers, graphene is obtainable by mechanical cleavage. In 2004, graphene was successfully detached from highly oriented pyrolytic graphite (HOPG) having an AB-layered structure using an adhesive tape. However, this method has a problem that the yield is very low.

Thereafter, there have been proposed other techniques for mass production of graphene. However, the yield of graphene via chemical routes, which has been proposed for mass production, may be also very low because the ratio of residues in the centrifuged supernatant liquid is only ˜0.5%. Graphene formed on a metal substrate by chemical vapour deposition (CVD) is mostly in the form of multiple layers i.e., this material is azimuthally aligned graphite rather than graphene.

When graphene has a zigzag configuration, it has half-metallic properties showing an excellent electrical characteristic, thereby advantageous in the fabrication of an element. However, graphene ribbons having a zigzag (or armchair) configuration have not been able to be fabricated with any of the foregoing existing methods.

On the other hand, ultrasonic treatment has been carried out for the purpose of dispersion of carbon nanotubes (particularly, single-wall carbon nanotubes). The ultrasonic (or thermal) treatment damages the carbon nanotubes.

### SUMMARY OF THE INVENTION

Therefore, an object of the present invention is to provide a method of fabricating pure graphene ribbons (single-layered graphene with a thickness of 4 Å) having a zigzag or armchair configuration in a simple manner and in a large quantity.

The foregoing objective may be accomplished by a method of fabricating graphene ribbons, including (a) preparing a carbon structure in which graphene has helically grown (graphene helix) by a chemical vapor deposition (CVD) method, and (b) applying energy to unroll the graphene helices into graphene ribbons.

According to the present invention, graphene ribbons having better physical properties than commercialized carbon nanotubes can be fabricated in a simple manner and in a great quantity. The graphene ribbons obtained by the present invention may be applicable to various fields such as a next-generation electronic devices including a field effect transistor (FET), bio- and gas-sensors, and the like.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIGS. 1A and 1B are schematic diagrams illustrating the growth process of a carbon structure in which a graphene ribbon is spirally grown (a graphene helix), revealing a tube shape used in the present invention; and

FIG. 2 is a view illustrating the process of fabricating the graphene ribbon having a zigzag configuration according to an embodiment of the present invention.

### DETAILED DESCRIPTION OF THE INVENTION

A method of fabricating graphene ribbons according to the present invention may be implemented by including preparing a carbon structure in which a graphene ribbon is spirally grown (a graphene helix), revealing a tube shape using a chemical vapor deposition (CVD) method, and applying energy to unroll the graphene helix into the graphene ribbons.

The carbon structure may have a zigzag or armchair configuration, and the carbon structure may be 0.3-10 nm in diameter and 100 nm-5 μm in length. On the other hand, the length of the graphene ribbon may be less than the length of the carbon structure, and the width thereof may be less than 5.3 times of the diameter of the carbon structure, and the graphene ribbon may have a zigzag or armchair configuration.

The energy applied to a carbon structure may be ultrasonic energy or is thermal energy.

In addition, the method may further include the step of milling and cutting the carbon structure, prior to applying energy to a carbon structure.

The present invention will be described in more detail with reference to the attached drawings.

### Preparing a Carbon Structure

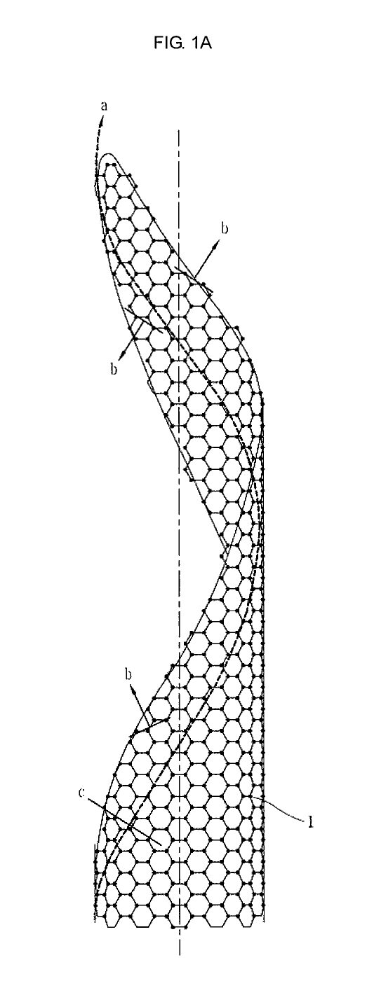

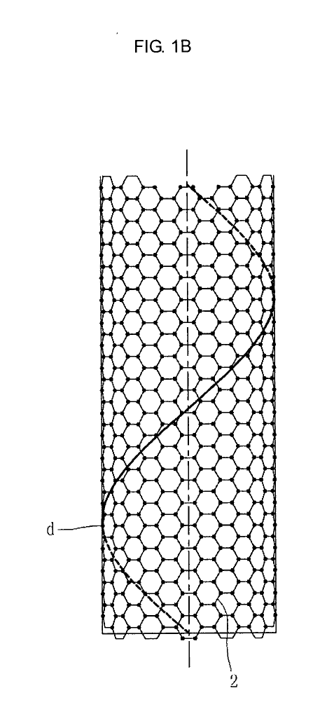

For a carbon structure used in the present invention, a carbon structure in which a graphene ribbon revealing a tube shape is spirally grown through a chemical vapour deposition (CVD) process to form a tube shape (FIGS. 1A and 1B).

When graphene ribbons have been spirally grown, it becomes more stable in energy than the case of a complete cylindrical tube shape which is not a spiral growth. In other words, the strain energy of graphene when graphene has been grown to spiral ribbons is less than by about ¼ or less when it has grown to a complete cylindrical tube shape.

Furthermore, one graphene ribbon is spirally grown to be existed independently without being layered, and thus it is easy to become single-layered pure graphene in the subsequent process. If graphene is formed with a layered structure, then it may be difficult to become single-layered pure graphene.

For graphene ribbons constituting the carbon structure having a tube to shape, graphene may be grown in the direction perpendicular to a zigzag line (c) (FIG. 1A), and the being grown in a zigzag configuration becomes more stable in energy. According to the measurement result, the strain energy of a zigzag configuration (FIG. 1A) is shown less than by ⅓ or less the strain energy of an armchair configuration (FIG. 1B). As a result, the zigzag-structured ribbon shape is is typically found in nature than the armchair-configurated ribbon shape.

In the aspect of a tube shape, they have an opposite structure to each other. In other words, the zigzag and armchair ribbons have the armchair and zigzag tube shapes, respectively. From the viewpoint of the process of forming a tube shape, a process of transforming graphene ribbons from a zigzag configuration to an armchair configuration is as follows. Graphene is grown in the direction perpendicular to a zigzag line (c) (FIG. 1A), and the growth-completed carbon structure becomes an armchair tube shape (FIG. 1B).

The tube-shaped carbon structure is 0.3-10 nm, preferably 0.4-5 nm in diameter, and several hundreds of nm to several μm, preferably 100 nm-5 μm in length. The carbon structure may be so called a single wall carbon nanotube (SW CNT).

### Obtaining Graphene Ribbons

Next, energy is applied to a carbon structure prepared as described above to be spread out as graphene ribbons that have been spirally grown to form a tube shape, thereby obtaining single-layered pure graphene ribbons.

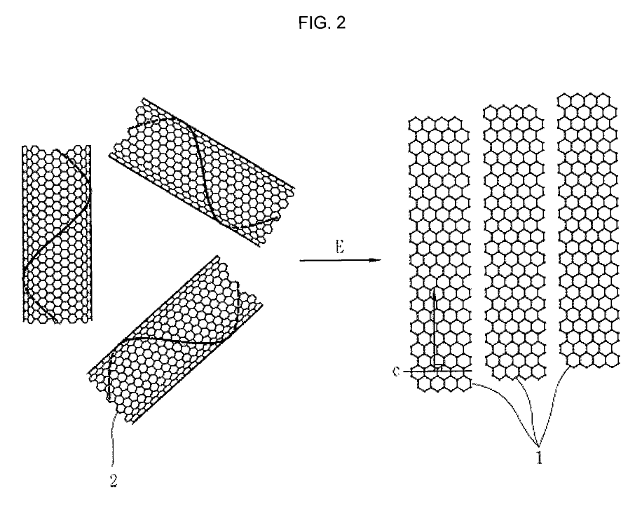

For the energy applied to tube-shaped graphene ribbons (“E” in FIG. 2), ultrasonic energy or thermal energy is used.

In case of applying ultrasonic energy, ultrasonic treatment is carried out in a solution, wherein alcohol, isopropyl alcohol, or the like may be typically used for the solution.

The transformation ratio from a carbon structure to graphene ribbons may vary depending on milling or non-milling of the carbon structure, power of the ultrasonic wave generator, length of the carbon structure. The relationship is illustrated in Table 1.

TABLE 1
(Unit: %)

| Ultrasonic | Treatment Time (hr) | | | | |
|---|---|---|---|---|---|
| Power (W) | 2 | 4 | 6 | 8 | 10 |
| 300 | 1 (5) | 3 (11) | 6 (14) | 8 (21) | 11 (32) |
| 500 | 5 (10) | 12 (19) | 20 (30) | 27 (62) | 33 (81) |

As illustrated in Table 1, it was found that the transformation ratio is higher as the ultrasonic wave treatment time becomes longer and the ultrasonic power becomes higher, and especially as shown in parentheses, the transformation ratio is greatly increased when passed through a pre-treatment process of cutting a carbon structure through milling.

On the other hand, when thermal energy is applied, the treated graphene ribbons are not existed as each single-layered pure graphene, and layered on one another to be a graphite state, and thus the treatment is preferably carried out subsequent to dispersing a specimen into a single layer on a substrate. The transformation ratio based on thermal treatment temperatures is illustrated in Table 2.

TABLE 2
(Unit: %)

| | |
|---|---|
| | Treatment |
| Thermal Treatment | Time (hr) |

| Temperature (° C.) | 1 | 2 |
|---|---|---|
| 500 | 1 (5) | 3 (11) |
| 1000 | 12 (18) | 15 (22) |
| 1500 | 42 (51) | 52 (67) |
| 2000 | 91 (95) | 100 (100) |

As illustrated in Table 2, it was found that the transformation ratio is higher as the thermal treatment time becomes longer and the thermal treatment temperature becomes higher, and especially as shown in parentheses, the transformation ratio is greatly increased when passed through a pre-treatment process of cutting a carbon structure through milling.

The energy applied to a carbon structure is not limited to two kinds of the ultrasonic energy and thermal energy, and any other method such as ion beam or the like may be used.

Furthermore, when passed through a pre-treatment process of cutting a carbon structure through milling to shorten the length thereof, the length of fabricated graphene ribbons is short, but the transformation ratio is greatly increased, thereby allowing a lot of graphene ribbons to be fabricated in a short period of time (see parentheses in Tables 1 and 2).

The diameter of fabricated graphene ribbons may be up to about 5.3 times of the diameter of nanotube (less than 5 nm), which is a raw material, and also may be less than about 30 nm.

Hereinafter, although the present invention will be described in detail through examples, those examples are merely provided to more clearly understand the present invention, but not provided for the purpose of limiting the scope of the present invention, and consequently, the true technical protective scope of the present invention should be determined based on the technical spirit of the appended claims.

### Example 1

Graphene ribbons were fabricated by using a carbon structure (raw material) in which graphene ribbons having a zigzag configuration fabricated in the chemical vapour deposition (CVD) process had been spirally grown to form a tube shape. The carbon structure, which is a raw material, was 1-4 nm in diameter, and 1 μm in length. The carbon structure, which is a raw material, was treated in an ultrasonic device (power 500 W). The transformation ratio based on the ultrasonic treatment condition is illustrated in Table 1. The solution used for ultrasonic treatment was alcohol. As a result of observing the ultrasonic treatment specimen using a scanning electron microscope and a transmission electron microscope, graphene ribbons with a width of 10-25 nm and a length of less than 1 μm were obtained. As a result of analyzing the specimen with a scanning tunneling microscope (STM), it was confirmed that it had a zigzag configuration.

### Example 2

The carbon structure, which is a raw material as in Example 1, was cut with ball-milling for 10 minutes, and then treated for 4 hours in the ultrasonic device (power 500 W). The solution used for ultrasonic treatment was alcohol. The transformation ratio based on the treatment condition is illustrated as parentheses in Table 1. As a result of observing the ultrasonic treatment specimen using a scanning electron microscope and a transmission electron microscope, graphene ribbons with a width of 10-25 nm and a length of 50-300 nm were obtained. As a result of analyzing the specimen with a scanning tunneling microscope (STM), it was confirmed that it had a zigzag configuration.

### Example 3

Graphene ribbons were fabricated by applying energy to a carbon structure, which is a raw material as in Example 1. The carbon structure, which is is a raw material, was dispersed not to be layered on a ceramic substrate having a mirror surface, thereby not allowing the obtained graphene ribbons to be layered to form graphite. The specimen prepared on the ceramic substrate was placed into a high vacuum heat treatment furnace for thermal treatment. The heat treatment temperatures were changed in the range of 500-2000° C. The transformation ratio based on the heat treatment temperature is illustrated as parentheses in Table 2. As a result of observing the transformed graphene ribbons using a scanning electron microscope and a transmission electron microscope, the graphene ribbons with a width of 10-25 nm and a length of less than 1 μm were obtained. As a result of analyzing the specimen with a scanning tunneling microscope (STM), it was confirmed that it had a zigzag configuration.

Though the present invention has been described with reference to preferred embodiments, these are merely illustrative, and it should be understood by those skilled in the art that various modifications and equivalent other embodiments of the present invention can be made.

What is claimed is:

1. A method for fabricating graphene ribbons, the method comprising:
(a) preparing a carbon structure in which a graphene ribbon is spirally grown (a graphene helix), revealing a tube shape; and
(b) applying energy to unroll the graphene helix into the graphene ribbons.

2. The method of claim 1, wherein the carbon structure has a zigzag or armchair configuration.

3. The method of claim 1, wherein the carbon structure is 0.3-10 nm in diameter and 100 nm-5 μm in length.

4. The method of claim 1, wherein the length of the graphene ribbon is less than the length of the carbon structure, and the width thereof is less than 5.3 times of the diameter of the carbon structure.

5. The method of claim 1, wherein the graphene ribbon has a zigzag or armchair configuration.

6. The method of claim 1, wherein the energy is ultrasonic energy or thermal energy.

7. The method of claim 1, further comprising:
milling and cutting the carbon structure between the steps (a) and (b).
